(19) United States
(12) Patent Application Publication
(10) Pub. No.: US 2002/0030335 A1
(43) Pub. Date: Mar. 14, 2002

(54) Waste disposal cart and system

(75) Inventor: Robert Moore, Richmond, VA (US)

Correspondence Address: MILLEN, WHITE, ZELANO & BRANIGAN, P.C., 2200 CLARENDON BLVD., SUITE 1400, ARLINGTON, VA, 22201, US

(73) Assignee: Modern Compaction, Inc., Richmond, VA

(21) Appl. No.: 09/946,479

(22) Filed: Sep. 6, 2001

Related U.S. Application Data
(63) Continuation of application No. 09/264,673, filed on Mar. 9, 1999, now abandoned.

(51) Int. Cl. B62D 39/00

(52) U.S. Cl. 280/33.995

(57) ABSTRACT

A waste disposal cart and system is provided that is portable and easily managed by a user. A waste cart is mountable within a trash compactor and is also portable so that it can be removed from the compactor for storage once it is full. An empty cart can subsequently be mounted in the compactor for handling of further waste.

A container for holding waste comprises front, back and side walls and a base connected to the bottom of the front, back and side walls. The base is angled so that when the container is in an upright position, at least a portion of the base slopes downwardly from the front wall toward the back wall. A first set of wheels is connected to the container whereby the wheels carry the weight of the cart and allow it to be maneuvered. A handle is attached to the back wall of the container that is defined by the base, and the front, back and side walls and a perforated sheet. In accordance with this structure, waste liquids deposited in the container may pass through the perforated sheet and be collected into the chamber in the bottom of the container.

This application is a continuation of U.S. patent application Ser. No. 09/264,673, filed Mar. 9, 1999.

### BACKGROUND OF THE INVENTION

The present invention relates to waste disposal systems and methods of disposing of waste. More specifically, the invention relates to a new waste disposal cart and the use of the cart to efficiently handle compacted waste.

Waste collection and disposal is a major concern for both individuals and corporations. Waste takes up space and can be both unpleasant and unhealthful. At the very least, it smells unattractive and vermin that are drawn to it can be a nuisance. Typically, on a larger scale, waste is collected and stored in large bins also referred to as dumpsters. Dumpsters are unsightly in and of themselves. In addition to this unsightliness, dumpsters must be emptied by large trucks, and the cost of disposal is relatively high—usually directly corresponding to the frequency a dumpster is emptied.

Dumpsters are unsightly and tend to smell. They are magnets for rats and other types of vermin. The smell can become a hazard to persons living or working nearby who may complain. In this sense, dumpsters are potentially a very contentious issue. One attempt to resolve this unsightliness and unpleasantness is expensive construction or landscaping to “hide” the ugly dumpster and to try to keep vermin away from the dumpster. This is very expensive and can take a lot of space. Typically, it sill cannot hide the unpleasant smells.

One way to handle waste more efficiently is to compact it. There are many types of compactors known and used in the industry including both portable and permanent models. Large, institutional facilities use huge containers and massive compactors to handle the mountains of waste created by, for instance, a large hospital or comparably sized facility. At the opposite end of the compactor market is the household compactor that fits neatly under a kitchen counter and creates a manageable-sized bag of waste. In between these two extremes there are numerous medium-sized companies, for instance, fast-food restaurants, that may use different types of compactors to try to handle their waste. By compacting waste, it is possible to reduce the space taken up by waste but there is still the problem of having to dispose of the waste once it is removed from a compactor. It is typically still disposed of in a dumpster. One problem that arises in such a system is handling the weight of the compacted waste. It is difficult to transport compacted waste to a dumpster and then get it into the dumpster. Lifting devices pose problems with potential misuse and accidents. Usually, only certain employees can handle the heavy, compacted waste. Once hoisted into the dumpster, the waste can de-compact. In any event, there is still the problem of the dumpster occupying substantial space and giving off unpleasant smells. Also, the compactor mechanism itself may take up valuable space inside a facility.

At present, there is no way to efficiently dispose of compacted waste in carts if the only way a waste-hauling truck has to handle waste is the front-end, dumpster-type prongs that lift a standardized dumpster. These prongs cannot properly handle a small cart; therefore, if smaller lifting devices are not available, then carts may be unusable and ineffective. A waste hauler may be unable or unwilling to use a number of different, custom lifting devices at its waste pick-up accounts.

Carts have been used in connection with compactors to help transport waste from the compactor to the dumpster. Some of these carts fit into the compactor. The problem with these carts that fit into the compactors include difficulty of removal of the cart from the compactor when the cart is full. In other words, it may be hard to extract the cart from the compactor. Also, there is potential damage to the cart as a result of the compacting process. The wheels that carry the compactor may break or bend or become otherwise disabled during the compaction process.

### SUMMARY OF THE INVENTION

It is an object of the present invention to provide a waste disposal cart and system which will solve the foregoing problems. Further objects, characteristics and advantages of the invention will become apparent from a study of the accompanying drawings and of the description of an exemplary preferred embodiment given below and of accompanying claims.

This present application is directed to a waste disposal cart and system that is portable and easily managed by a user. The invention includes a waste cart that is mountable within a trash compacter and that is portable so that it can be removed from the compacter for storage once it is full and an empty cart can be mounted in the compactor for further filling.

In one embodiment, the invention describes a container for holding waste wherein the container comprises front, back and side walls and a base connected to the bottom of the front, back and side walls. The base is angled so that when the container is in an upright position, at least a portion of the base slopes downwardly from the front wall toward the back wall. A first set of wheels is connected to the container whereby the wheels carry the weight of the cart and allow it to be maneuvered. A handle is attached to the back wall of the container to allow maneuvering of the container. There is also a liquid collection chamber inside of the container that is defined by the base, and the front, back and side walls and a perforated sheet. In accordance with this structure, waste liquids deposited in the container may pass through the perforated sheet and be collected in the chamber in the bottom of the container.

In another embodiment, a waste disposal cart includes a frame and a container. The frame has a front side, a back side and a bottom and includes brackets for receiving the container. A first set of wheels is mounted on the bottom of the frame and a handle is attached to the back side of the frame. The bottom of the frame is angled so that when the frame is in an upright position, at least a portion of the bottom slopes downwardly from the front side toward the back side. The container includes a front wall, a back wall and side walls and a base. The container fits into the frame and further has a liquid collection chamber inside the container defined by the base, and the front, back and side walls and a perforated sheet.

Other features of the invention include a second set of wheels mounted toward the front of the base of the container or frame. There may also be a third set of wheels mounted at the rear of the bottom of the container or frame to allow the cart to be maneuvered safely and efficiently.

In a further embodiment, an adaptor for lifting a waste disposal cart includes a box and an engaging mechanism. The box has side walls, a back wall, a front gate and a base. The side walls have channels connected to each side wall, the channels adapted to receive dumpster prongs of a waste hauling truck, and the side walls spaced apart to a width equal to a width between dumpster prongs. The base includes means for supporting a waste disposal cart. The front gate may be opened and closed and the engaging mechanism locks the waste disposal cart into the adaptor when the front gate is in the closed position.

### BRIEF DESCRIPTION OF THE DRAWINGS

FIG. 1 is a rear, perspective view of a preferred embodiment of a waste disposal cart comprising the present invention.

FIG. 2 is a side elevation view of a waste disposal cart of the present invention wherein the handle and lifter receiving component are shown in the upright or extended position.

FIG. 3 is a side elevation view of a cross section of the waste cart of the present invention shown in FIG. 2.

FIG. 4 is a cross section of the waste disposal cart of the present invention shown in a portion of a trash compactor wherein a pressure plate is shown in the partially compacted position.

FIG. 5 is a perspective view of the frame portion of one preferred embodiment of the waste disposal cart of the present invention.

FIG. 6 is a top elevation view of the waste cart of the present invention.

FIG. 7 is a top elevation view of the foundation of the trash compaction chamber.

FIG. 8 shows a front elevation of a compacting mechanism in the down or compacted position.

FIG. 9 is a front view of an embodiment of a control panel for operating the compacting mechanism.

FIG. 10 is a perspective view of the sheet that is placed in the bottom of the container in a preferred embodiment of the present invention.

FIG. 11 is a bottom elevation view of the top of the container in one embodiment of the present invention.

FIG. 12 is a perspective view demonstrating how the top shown in FIG. 11 connects to the container in one embodiment of the present invention.

FIG. 13 is a perspective view of a plurality of waste carts of the present invention together with a storage facility for those carts.

FIG. 14 is a perspective view of one embodiment of an adaptor for storing and allowing lifting of the waste carts in accordance with the present invention.

FIG. 15 is another perspective view of the adaptor shown in FIG. 14.

FIG. 16 is a perspective view of another preferred embodiment of the waste disposal cart of the present invention.

FIG. 17 is a top elevation view of another embodiment of an adaptor for storing and allowing lifting of the waste carts in accordance with the present invention.

FIG. 18 is a cross-sectional view of an adaptor with a waste cart mounted in it in accordance with the present invention.

### DETAILED DESCRIPTION OF A PREFERRED EMBODIMENT

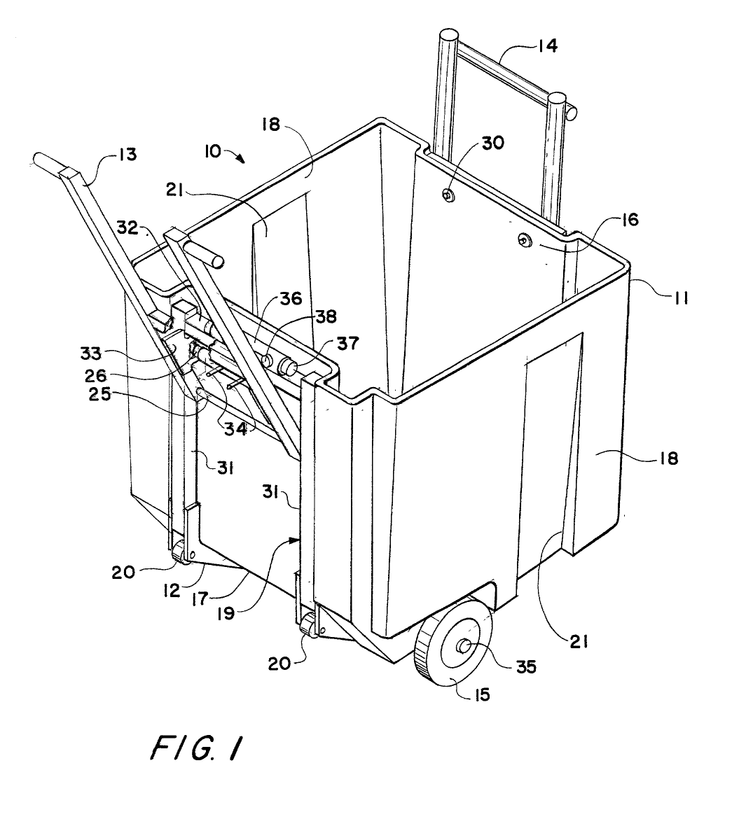

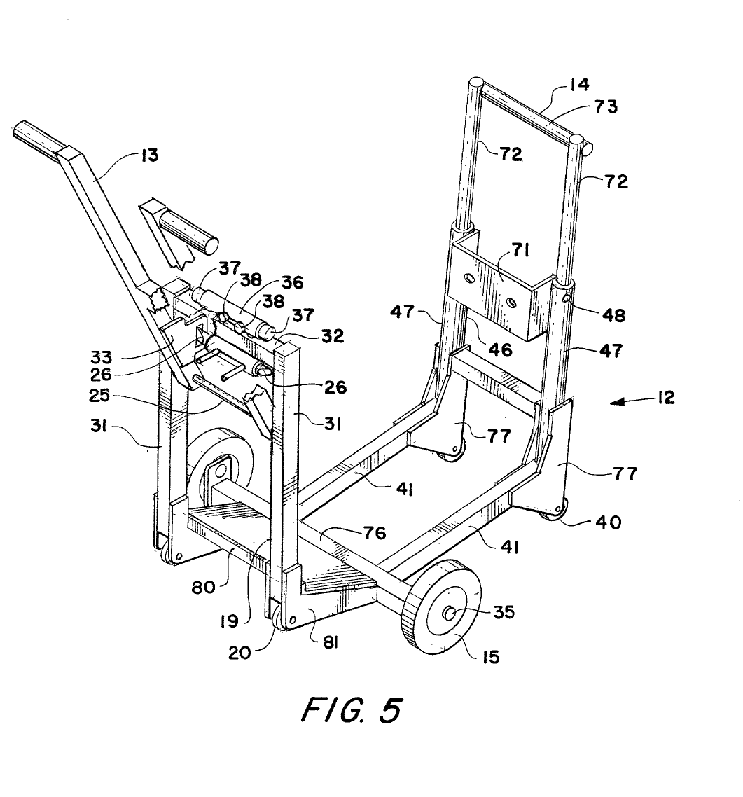

FIG. 1 illustrates a preferred embodiment of the waste disposal cart of the present invention. The cart 10 is made up of a container 11 that fits within a frame 12. The frame 12 is shown without the container 11 in FIG. 5. In FIG. 1, the container 11 is shown as having a generally rectangular construction with a front wall 16, back wall 17, and side walls 18. There is also shown a lifter receiving component 14 that is connected to the frame 12 and is adjacent the front wall 16. There is also disclosed the handle 13 that is connected to the frame 12 and is adjacent the back wall 17.

The container 11, is made of a durable plastic material such as cross-link, density polyethylene or other polymer. The container 11 may be made from an injection molded process or preferably a rotational molding process. Plastic is the preferable material to work with, because it is lightweight yet strong enough to hold the compacted waste. In a preferred embodiment, the thickness of the plastic walls and base of the container 11 is in the range of ¼″ to ⅜″.

The container 11 includes the front wall 16, back wall 17, and side walls 18. The side walls 18 include ridged portions 21 that provide strength and rigidity to the side walls 18. The front wall 16 and back wall 17 likewise contain ridges along their vertical lengths into which portions of the frame 12 are fitted. The base of the container 11 is not shown in FIG. 1. It makes up the bottom of the container and is connected to the bottom of the front wall 16, back wall 17 and side walls 18. The base is formed to fit into the bottom of the frame 12. The container 11 is bolted to the frame 12 by means of bolts 30. The bolts 30 are connected to a crossbar or other frame piece (not shown) that may comprise a portion of the front of the frame 12 at the discretion of a designer of skill in the art. Other bolts (not shown) may also attach the back side 17 of the container to the back 19 of the frame. These bolts removably attach the container 11 to the frame 12. In this manner, if the container 11 were to break or otherwise leak and become unusable, then the plastic container 11 could be unbolted and replaced with a new container. The frame 12 includes a front side (not shown) and a back side 19. The back side 19 is made up of two vertical brackets 31 connected by a pivot bar 25. In this way, the handle 13 will rotate about the pivot bar 25 so that the handle is in the upright position shown or in the closed or down position (not shown) for loading into a compactor or adaptor. To maintain the handle 13 in the upright position, there is a spring bolt 26 that passes through plates 33 on the handle 13. This spring bolt 26 may be disengaged from the plates 33 by pinching together pins 34. Alternatively, other locking mechanisms including a spring lock or other support mechanisms may be employed.

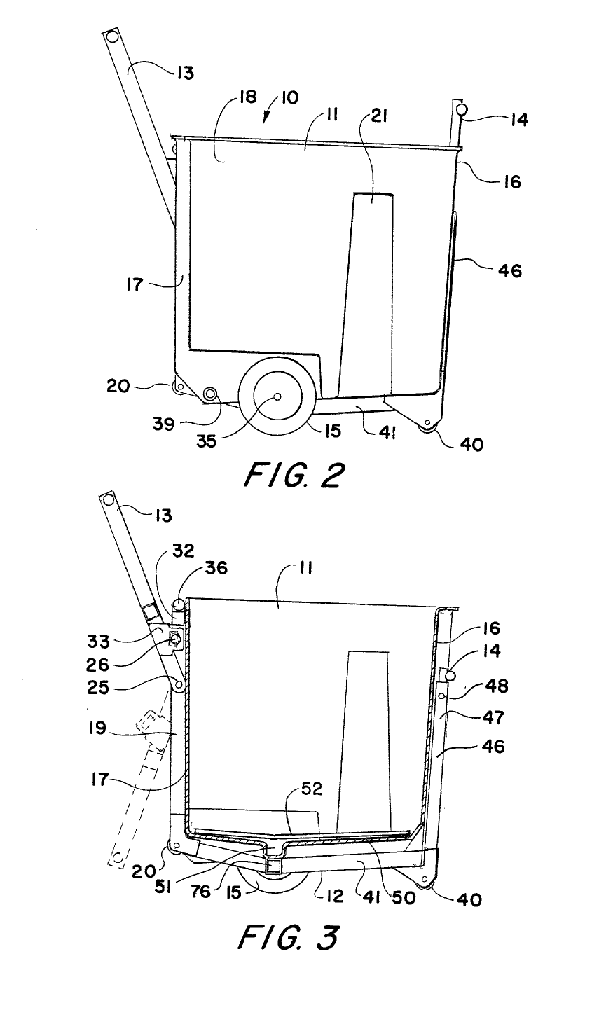

A pair of wheels 15 (only one of which is shown) is connected by an axle 35 to the bottom of the frame 12. This first set of wheels 15 preferably have a relatively wide diameter of at least six inches so that the cart may be easily maneuvered and wheeled about. The wheels 15 are mounted to the frame 12 preferably towards the back side 19 of the frame 12. In this way, a user has a better leverage when pulling on the handle 13 to maneuver and wheel about the cart 10. In a preferred embodiment, as shown more clearly in FIG. 2, the wheels 15 are mounted to the frame 12 approximately 40% of the distance from the back side 19 to the front side.

Also in FIG. 1, there is shown another set of wheels 20 that are attached to the bottom of the back side of the frame 12. This pair of wheels 20 allows a user to tilt the cart 10 backwards towards a user and allows the wheels 20 to help bear the weight of the cart 10 when it is tilted backwardly. When the cart 10 is in the upright position shown in FIG. 1, the set of wheels 20 are not in contact with the ground. This third set of wheels 20 only contacts the ground when the cart is tilted backward when it is being maneuvered, for instance, after the cart 10 has been removed from a trash compactor.

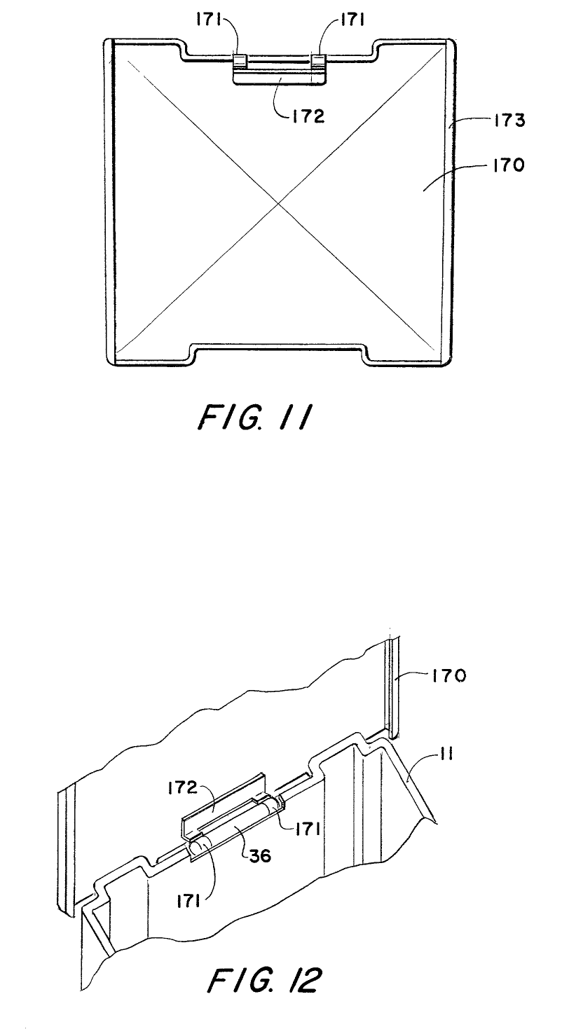

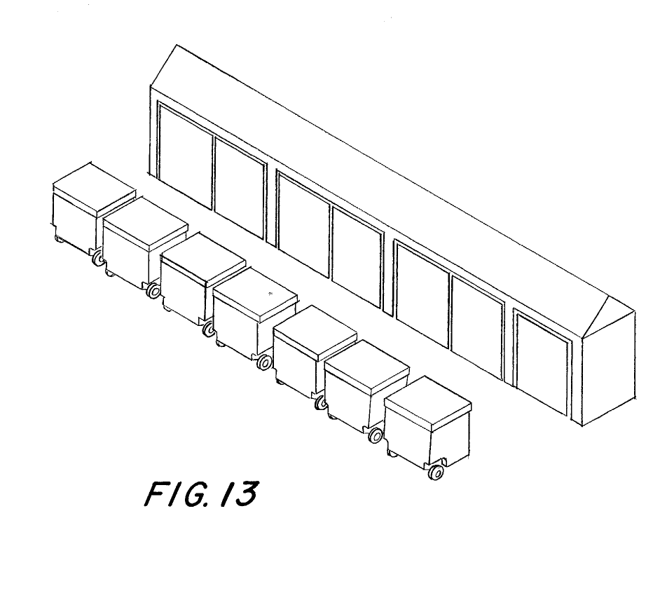

A bracket 36 is mounted to the crossbar 32. The bracket 36 has spring hinges 37 mounted within it. There are further shown tabs 38 that may be pinched together to pull the hinges 37 into the bracket 36. The hinges 37 are biased by a spring within the bracket 36 to maintain the hinges in the extended position until the tabs 38 are squeezed together. The bracket 36 is used to removably attach the top 170 to the container 11 as will be discussed more fully in connection with FIGS. 11 and 12.

The side walls 18 are not vertically parallel to each other. Likewise the front wall 16 and the back wall 17 are not vertically parallel to each other. The opposite set of walls 18, and 16 and 17, are in a diverging relationship. In other words, the side walls 18 are closest to each other at the bottom of the container 11. From that point, as they extend upwardly, the side walls 18 diverge so that they are farther apart from each other at the top of the container 11. In practice, the divergence is relatively slight, approximately 2-3 degrees from true vertical. This divergence is also true for the front and back walls 16 and 17. This divergence allows for better ease of manufacturing the container. It also facilitates removal of the cart 10 from a compactor by reduced friction with the walls inside a compaction chamber. The diverging or tapered relationship of the walls of the container also facilitate the evacuation or dumping of the waste out of the container. Those of skill in the art will know how to manipulate the degrees of divergence to meet the needs of various cart/compactor assemblies that may be desired or required.

Additionally, FIG. 1 depicts a combination of the frame 12 and container 11. Those of skill in the art will understand that it would be possible to design a unitary cart design wherein a handle and wheels and, if desired, a lifter receiving component similar in function to lifter 14, may be directly attached to a container used to haul waste. In other words, a separate frame to carry the container would be unnecessary. The container could include virtually all of the features described above and later herein, only without a separate frame. The handle could be attached to the back wall of a container, and wheels could be attached to the container to carry the weight of the container so it could be maneuvered about.

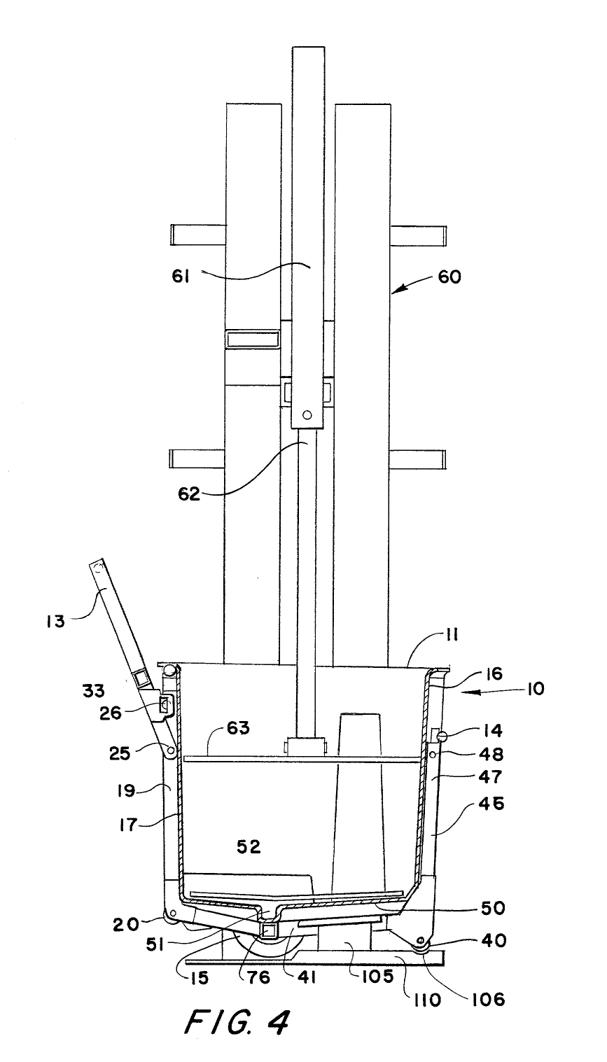

FIGS. 2 and 3 display side views of the cart 10. FIG. 2 illustrates a side view of the cart 10 in which the lifter receiving component 14 and the handle 13 are in the upright or extended positions. Adjacent to front wall 16 of the container 11 is the lifter receiving component 14. This component 14 is attached to the front side 46 of the frame 12. The front side 46 of the frame 12 is made up of hollow tubes 47 that receive the component 14. The component 14 may be in the extended, upward position and locked in place by a spring bolt 48, or in the closed, downward position (FIG. 3). A set of wheels 40 is mounted on the front end of the bottom 41 of the frame 12. This set of wheels 40 carries some of the weight of the cart 10 when the cart is in the upright position as shown. The third set of wheels 20 is shown in the relatively elevated position so that they are not touching the ground when the cart 10 is in the upright position as shown. The third set of wheels 20 will only touch the ground when the cart 10 is tilted backwardly. In that event the second set of wheels 40 is lifted so that they are no longer touching the ground. There is also shown a drain hole 39 that is an access to the inside of the container 11. The hole 39 may be opened so that fluids that have collected inside the container 11 can be removed. In addition to a simple drain hole that my be opened or closed, a connector can be mounted at the bottom of the container. The connector is adapted to be connected to a hose for pumping fluids out of the container. A container may even have both a drain hole and a connector, for instance on opposite sides of the container, to allow passive draining or pumping.

The second and third sets of wheels 40 and 20 respectively, are rigid, caster-type wheels that are not swivelable. These wheels 40 and 20 are very useful, in connection with wheels 15, in handling and moving a cart over flat, firm ground such as smooth concrete or asphalt. Alternatively, those of skill in the art will be able to substitute larger diameter wheels for the wheels 40 and 20, and even wheels 15, in order to allow a cart to be easily handleable and transportable over an uneven surface such as gravel or cobblestones. The diameters of these wheels could be six inches or larger. The system described herein would be adapted accordingly to accommodate the modification.

The slight divergence of the front wall 1 and back wall 17 is also shown in both FIGS. 2 and 3 discussed earlier.

FIG. 3 is a cross sectional view of the cart 10 that provides a better view of the inside of the container 11. As seen in FIG. 3, the bottom 41 of the frame 12 has mounted on it each of the sets of wheels including the first set 15, the second set 40 and the third set 20. It is on the bottom 41 of the frame 12 that the base 50 of the container 11 rests. In this cross section, the base 50 of the container 11 is shown sloping from the front side 16 of the container towards the back side 17 of the container with a low point being above the bottom cross member 76 which is the relatively lowest point of the bottom 41 of the frame 12. The base 50 also includes a rear portion that slopes downwardly from the back side 17 towards the front of the container 11. In this way, there is formed a collection chamber 51. Resting on the base 50 of the container 11 is a perforated sheet 52 that is likewise sloped downwardly from the front side 16 towards the collection chamber 51 and downwardly from the back side 17 to the collection chamber 51.

FIG. 3 also displays how the handle 13 attached to the crossbar 32 when the handle is in the upright position. As shown, a flat plate 33 of the handle 13 is removably attached to the back side of the frame 19 by a spring bolt 26. In this way, the handle 13 can be locked in the upright position to provide for handling of the cart 10. When the bolt 26 is squeezed to detach the handle 13, the handle rotates about the pivot bar 25 to its down or closed position. Similarly, the lifter receiving component 14 telescopes up and down in the tubes 47 to move from its upright position to its down and closed position.

FIG. 4 illustrates the waste cart 10 illustrated in FIG. 3 as it fits in a waste compacting mechanism 60. The compacting mechanism 60 is a frame on which is mounted a rod 62 inside a cylinder 61. The rod 62 moves up and down within the cylinder 61 pursuant to conventional hydraulic means. The rod 62 is attached to a pressure plate 63 which is a flat portion of hard material, preferably steel, that is used to compress waste that is disposed within the container 11. The pressure plate 63 will reciprocate up and down as needed to compress waste. FIG. 4 merely illustrates how the pressure plate moves up and down in the waste cart 10. FIG. 8 illustrates more detail regarding the structure of the waste compacting mechanism 60.

FIG. 5 is a drawing of the frame 12 that supports a container (not shown). The frame includes a front side 46, a bottom 41, and a back side 19. The front side 46 includes two vertical hollow tubes 47. The lifter receiving component 14 is made up of two vertical members 72 and a crossbar 73. The members 72 slide up and down within the tubes 75. A bracket 71 is attached to the vertical tubes 47 that allows for a container to be bolted to the frame 12. When the lifter receiving component 14 is in the extended position, the cross bar 73 and a second crossbar (not shown behind the bracket 71) are engagable with conventional waste cart lifting mechanisms. An example of conventional waste cart lifting mechanism is Ameri-Kart Corp., Dumper Model 3. The tubes 47 that comprise a portion of the front side 46 are connected to the bottom 41. At the point where the tubes 47 and the bottom 41 are joined, there are wheel supports 77 that are connected to the second set of wheels 40. When the frame 12 is in the upright position as shown where the first set of wheels 15 and the second set of wheels 40 are resting on the ground, the bottom 41 slopes downwardly from the front side 46 to the bottom cross member 76 which serves as the support for the first set of wheels 15. The bottom cross member 76 also carries the axle 35 onto which the wheels 15 are mounted and rotate about. The back side 19 of the cart 12 includes vertical brackets 31 and a cross member 32 connecting the tops of the brackets 31. The brackets 31 are connected on the bottom to a rear wheel support 81 that is in turn connected to the bottom cross member 76. There is also a rear base panel 80 that is attached to the rear wheel supports 81 and to the bottom cross member 76. Th rear base panel 80 slopes downwardly from the back side 19 to the bottom cross member 76. The handle 13 is connected to the brackets 31 by the pivot rod 25. As shown, the handle 13 can be locked in the upward position by means of the spring bolt 26 and plate 33 that removably connect the handle 13 to the crossbar 32. The length of the handle 13 is limited in that when the handle is rotated in the down position, the handle must not be lower than the level of the first set of wheels 15. Nevertheless, it is desirable to have the handle 13 as long as possible so that appropriate leverage may be maintained to handle the cart. The frame 12 can be made of any light weight durable material. Preferably tubular steel or aluminum would be used, because the cart can be expected to be handled roughly when it is being maneuvered by a user and when it is being lifted by a waste disposal truck.

Although not shown in FIGS. 3 and 5, there is a second crossbar that is connected to the vertical hollow tubes 47 and that is parallel to the 11 crossbar 73. These two crossbars are engaged by the cart lifting mechanism. In the extended position, the crossbar 73 should be approximately 36 inches off the ground, and spaced 14.25 inches from the lower crossbar.

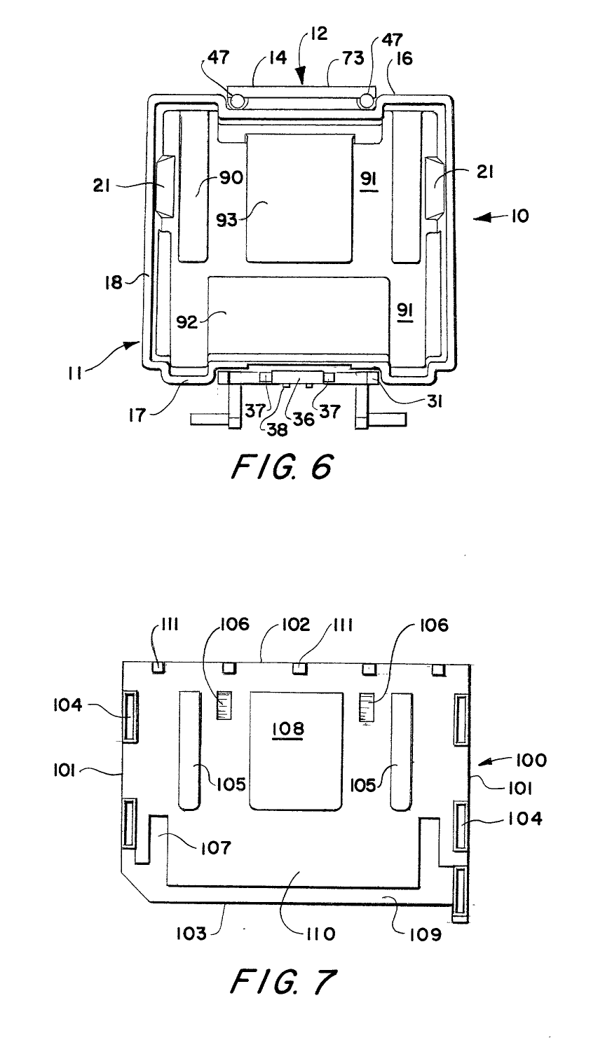

FIG. 6 is a top elevation view of the cart 10 including both the frame 12 and the container 11. The perforated sheet shown in FIG. 3 is not shown in FIG. 6. The perforated sheet wold cover the inside base of the container if it were to be shown in FIG. 6. The container 11 is held in place in the front by the tubes 47 and in the back by the brackets 31 shown in FIG. 6. The container 11 is held in place in the front by the tubes 47 and in the back by the brackets 31 shown in FIG. 6. The container 11 is resting on the bottom (not shown) of the frame. The front wall 16 and the back wall 17 of the container 11 are formed so that the brackets 31 and tubes 47 will fit around and hold the container 11 in place. As shown in FIG. 6, there are ribs 90 and base plate 93 that are spaced across the bottom of the container 11. These ribs 90 and base plate 93 are raised sections molded into the bottom of the container. There is also shown a raised rectangular section 92. The bottom of the container in between the ribs 90, base plate 93 and the raised portion 92 comprise a plurality of channels 91. When a perforated sheet (not shown) is placed in the bottom of the container, it is supported by and rests on the ribs 90, base plate 93 and raised portion 92. The area underneath the perforated sheet that is formed by the various channels 91 becomes a collection chamber for fluids that may be deposited into the cart.

It will also be noted in FIG. 6 that the width of the front side 16 of the container 11 is less than the width of the back side 17. In other words, the side walls 18 are not parallel, rather they are converging from the back side 17 to the front side 16 of the container 11. In this way, the container may be more easily removed from a waste compactor because there will be less friction contact between the side walls 18 and the inside of a trash compactor as the cart is being removed.

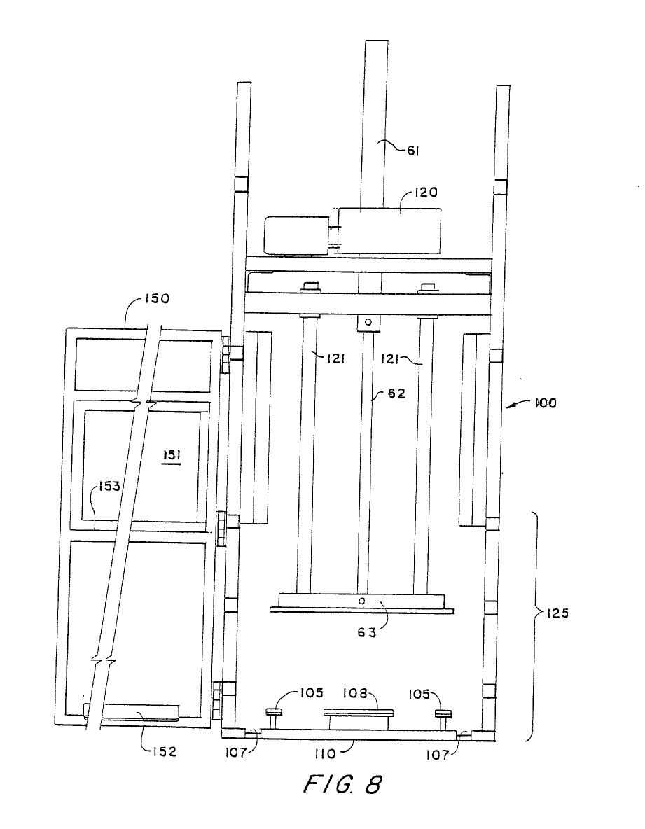

FIG. 7 is a top view of a waste compactor mechanism 100. This is specifically a top view of the foundation 110 or bottom of the compacting mechanism 100. The foundation 110 includes the front side 103, the back side 102, and the sides 101. The sides 101 are reinforced by vertical supports 104. The back side 102 is likewise supported by vertical supports 111. The foundation 110 includes two beams 105 and a support plate 108 that protrude upwardly from the bottom of the foundation 110. The tops of the beams 105 and a support plate 108 that protrude upwardly from the bottom of the foundation 110. The tops of the beams 105 and support plate 108 are inclined so that the end of the beams and plate are lower at the end closest to the door 150 and incline upwardly therefrom so that the angle of incline effectively matches the bottom 50 of the container 11. There is also included in the foundation 110 wheel wells 107 and 106. Wheel wells 106 are adapted to receive the second set of wheels 40 of the cart 10. Wheel wells 107, similarly, are adapted to receive the first set of wheels 15 of the cart 10. Along the front side 103 of the foundation 110, the edge 109 is beveled to allow the wheels to roll into the compaction chamber and into the designated wheel wells 106 and 107. When the wheels 40 drop into wells 106, the base of the cart, and specifically the ribs 90, and base plate 93 come into contact with and are supported by the beams 105 and support plate 108. This removes the weight from the wheels 15 and 40.

The walls or supports (not shown) that make up the inside, side walls of the compaction chamber may be parallel or converging with respect to each other. This relationship can be selected by one of skill in the art to support the side walls of a container to be mounted within the compactor. The shape or relative slope of the side walls would be chosen to both support the container during compaction and also allow easy removal of the cart when it is full. Also, the side supports inside the chamber do not need to be flat sheets. Simple tubing or support bars alone can support the container during use.

FIG. 8 displays the front view of the waste compactor apparatus 100. The bottom portion of the apparatus 100 is the waste collection chamber 125 which is designed to receive a waste cart such as waste cart 10 (FIG. 1). The apparatus 100 also includes the pressure plate 63 attached to the rod 62 that moves up and down in the piston 61. An actuator 120, typically a mechanical, hydraulic and/or electric motor, causes the upward and downward motion of the pressure plate 63. Stabilizer bars 121 help maintain the upward and downward motion of the pressure plate 63 in a straight fashion so that the pressure plate does not twist or compact unevenly.

FIG. 8 also displays a door 150 attached to the front of the compactor apparatus 100. The door 150 includes a chute 151 that may be opened and closed to allow users to deposit trash into a cart when it is mounted within the chamber 125. The chute 151 may be hinged along any side depending on the preference of the compactor designer. Preferably, the chute 151 is hinged along its bottom edge 153 to the door 150. A rear wedge 152 is attached to the base of the door 150. The rear wedge 152 is self-adjusting on wheels and is adapted to engage the rectangular section 92 of a cart when a cart is mounted in the chamber 125 and the door 150 is closed. In the closed position, the wedge 152 is in contact with the rectangular section 92 of the cart and the foundation 110 of the compaction chamber 125. This wedge 152 further supports the bottom of the cart in a similar fashion as the beams 105 and the support plate 108. The wedge 152 supports the cart during compaction and takes pressure off of the wheels of the cart.

The waste compactor used in connection with the present invention may be a portable or fixed unit. Preferably, to conserve space in a facility, for instance a fast-food restaurant, the compactor is mounted in a wall. This takes up less space inside. It also allows access to the compactor from outside the facility. For instance, the door of a compactor may be outside a facility to allow mounting and removal of a cart outside the facility. In this alternative, a trash chute would probably be placed in the back wall (the wall inside the facility) of the compactor. Those of skill in the art will understand the advantages of the inside/outside access to the compactor. They will also understand the multiple ways to integrate the compactor into the design of an existing or new facility.

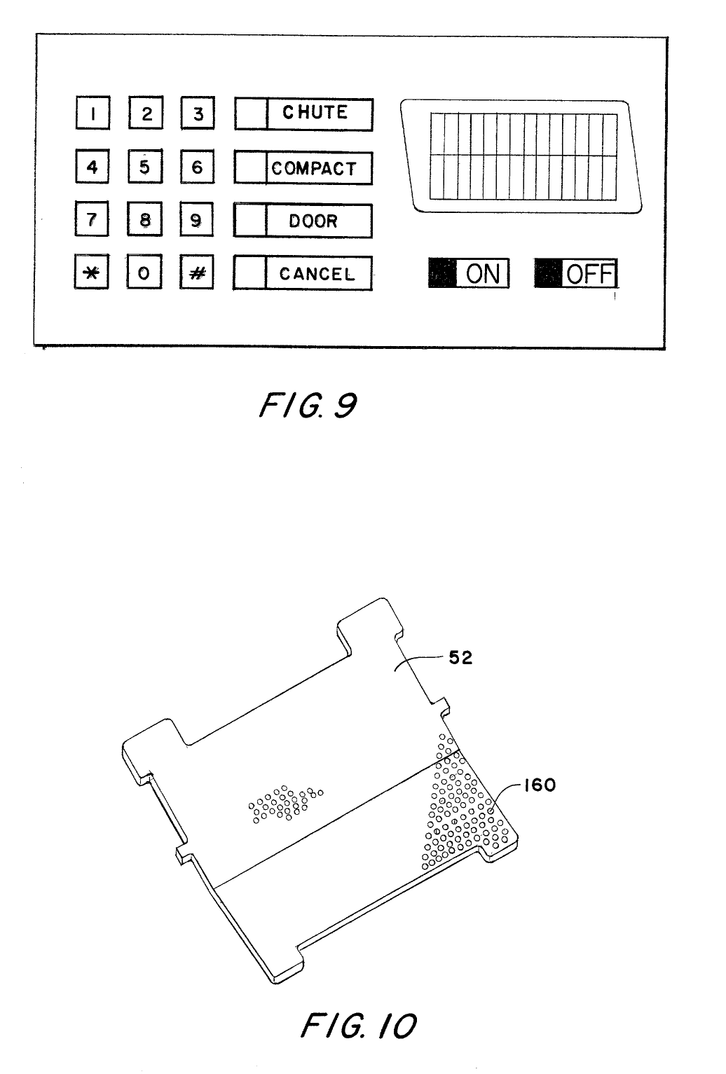

FIG. 9 depicts a control panel used to operate a waste compactor such as the waste compactor apparatus 100 shown in FIG. 8. The control panel in FIG. 9 would be placed on the front of the door 150. The control panel is interactive in that the LED screen can report the specific processes that the compactor is performing. It might also be used as a troubleshooting device in which warnings or other signals can be communicated to a user. In the center of the control panel, there is shown the buttons for a CHUTE, COMPACT, DOOR and CANCEL. The CHUTE button would operate to open, close and lock the chute 151 on the door 150. The COMPACT button is used to begin the compaction process. The DOOR button allows the door to be opened for insertion or removal of a waste cart. The CANCEL button is used to interrupt whatever process is going on and stopping it. The numbered control panel can be used for numerous purposes. There may be a password control programmed into the apparatus 100. In this way, only an authorized user may operate the equipment. Use of the control panel also prevents the user from inadvertently opening the door during a compaction process or at another unsafe time. The processor can include other safety features that require, for instance, the door and chute to be closed before the compaction process is engaged. Additional features might include a sensor on the pressure plate 62 which would indicate when the cart has reached its capacity so that the cart may be replaced in a timely fashion. Those of skill in the art will be able to think of numerous other functions that the control panel could perform. Other buttons and commands are also envisioned depending on the preference of a user. Finally, the specific circuitry and wiring will be known to one of skill in the art of microprocessors and software development for machine applications.

FIG. 10 displays a sheet 52 that fits inside the container 11 and rests on the bottom of the container on the ribs 90, base plate 93 and rectangular portion 92. As illustrated, the sheet 52 has perforations 160 across the face of it. Those perforations extend through the thickness of the sheet. The perforations 160 allow for fluids that are deposited in the container to drain into the bottom of a container into the fluid collection area 91 (FIG. 6). Alternatively, the sheet 52 is a solid surface. The dimensions of the sheet are slightly less (approximately ¼ inch to ½ inch less) than the actual inside dimensions of the container 11. In this way, there is a gap all the way around the outside edge of the sheet 52 between the sheet 52 and the walls 16, 17 and 18 of the container 11. Fluids may seep around the edge of the sheet 52 and into the collection chamber 91. The sheet 52 is preferably attached by some conventional means like a screw or molded nub to the container 11 so it doesn't fall out when the waste is dumped out of the container. The sheet 52 is preferably made of a stiff material such as aluminum, steel or hard plastic. Although it is supported by the various components of the bottom of the container, there is still considerable pressure as a result of the compaction process during operation. In a preferred embodiment, the sheet 52 is made up of high density polyethylene that is ½ inch thick.

FIG. 11 shows a bottom view of the top 170. The top 170 is sized to fit around the top of the container 11. The edge 173 of the top 170 effectively mirrors the edge of the top of the container 11. The top 170 further includes a hinge 172 having two hollow round rings 171. Those rings 171 engage the hinges 37. When the tabs 38 are squeezed together, the hinges 37 allow the rings 171 to slide in place around the bracket 36. When the tabs 38 are released, the hinges 37 extend into the inside of the rings 171. In this way, the top 170 is effectively rotatably attached to the container 11. Any type of latch assembly (not shown) is used to anchor the top closed in place once it is mounted and hingedly connected to the container 11. Additionally, a seal of foam or rubber or similar material can be adhered to the inside edge of the top to engage the top of the walls of the container and achieve a seal when the top is on the container. This helps to keep unwanted odors or other unhealthful gasses from escaping once the container is full.

FIG. 12 demonstrates exactly how the top 170 fits onto the container 11. There is shown the bracket 36 and rings 171 arranged so that they are rotatably interconnected.

FIG. 13 displays a plurality of waste carts 130 relative to a shed 140 for storage of a plurality of carts. The shed 140 includes separate bays 141 having doors that provide for storage of individual carts 130. As carts 130 are filled with compacted waste, they are wheeled into the storage bays 141. The bays 141 are also used to store empty carts waiting to be filled. When one or more of the carts 130 is filled with compacted waste, a waste hauler can come and empty the filled cart(s) by simply removing them from the shed and using conventional cart lifting mechanisms, as discussed earlier, to dispose of the waste.

While the storage system depicted in FIG. 13 is an efficient system for handling waste carts, the system requires that a waste hauler have the specific type of lifter apparatus that is used to lift carts only. This type of device is typically a side or rear-mounted mechanism. Some waste haulers, however, only use trucks having a front-end, dumpster type of lifting mechanism. These front-end dumpster type mechanisms are typically mounted on the front end of a truck and are made up of two prongs that extend forwardly from the truck that engage and lift the traditional dumpster-type of waste container. In practice, these dumpster containers are substantially larger than the smaller carts that have otherwise been discussed herein. These dumpster prongs are conventionally spaced apart to an industry-recognized width of 76 inches. In this way, a waste hauling truck having this dumpster prong lift mechanism may be used to lift dumpsters at virtually all locations. There is no practical way to use this dumpster-type of lifting mechanism alone in connection with the carts described herein.

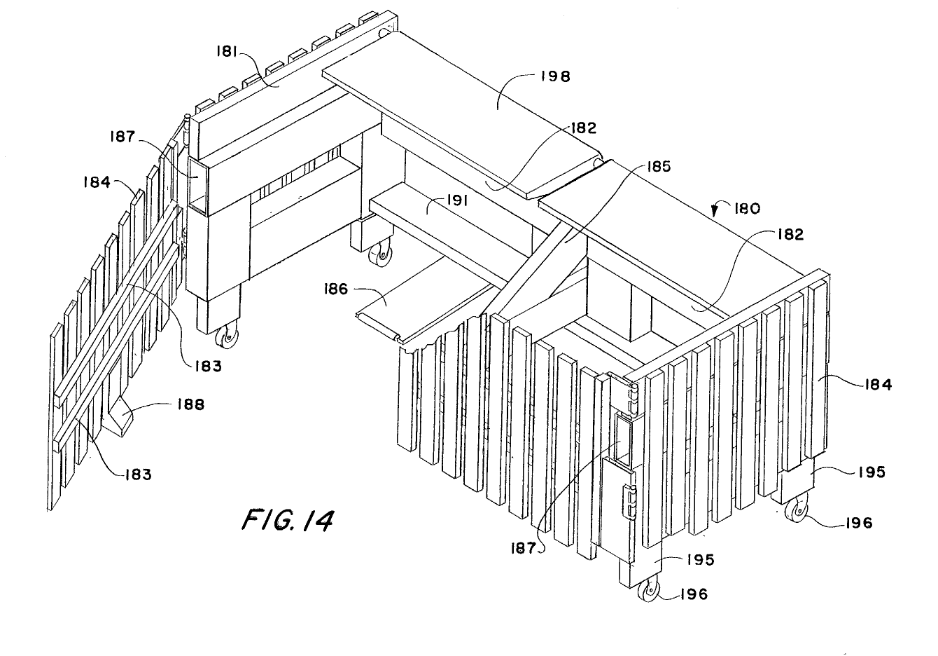

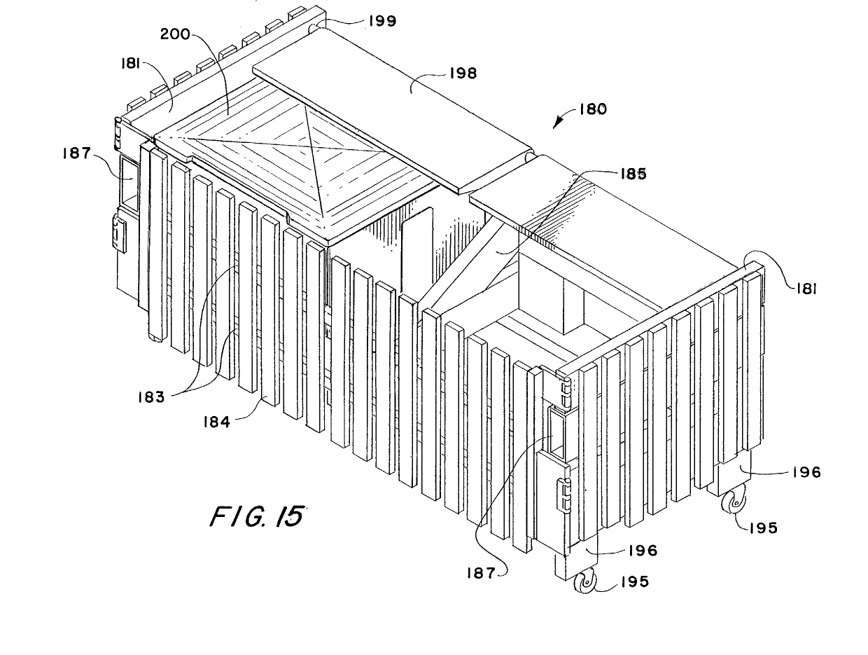

FIGS. 14 and 15 disclose an adaptor for housing a waste disposal cart, for instance such as cart 200, so that it may be lifted by the dumpster prongs described above. Specifically, the adaptor 180 is designed to be used in connection with a waste hauling truck having prongs to lift a waste container, the prongs being set apart at a width of 76 inches. The adaptor 180 is a box having side walls 181, a back wall 182, and a front gate 183. The side walls 181 and back wall 182 are rigidly attached to each other to give the adaptor 180 a rectangular shape. The front gate 183 is connected by a hinge 190 to the side wall 181. In this way, the front gate 183 may be opened and closed. There is further shown a center support strut 185 that is used to separate the two compartments in the adaptor 180. Mounted along the side walls 181 and the front gate 183 are shown decorative pickets 184 that give the appearance of a pleasing picket-fence display. Bottom struts 191 are part of the back wall 182 structure. Attached to those bottom struts 181 is a base or tongue 186. The tongue 186 is adapted to engage the base support portion 93 of a cart as shown in FIGS. 1 and 6. Obviously, the tongue 186 can be designed to specifically receive a cart having a different type and shape. It is preferable that the tongue 186 be of a sufficient height off the ground to support the cart that may be inserted in the adaptor 180, for instance as shown in FIG. 15. The side walls 181 include channels 187 that are hollow, rectangular tubes adapted to receive the dumpster prongs of the waste hauling truck. These channels are fixed into and are an integral part of the side walls 181. The front gate 183 also includes a foot wedge 188 that is connected to a cross member that defines the gate that, when the gate is in the closed position, is adapted to engage the raised rectangular section 92 of the cart as shown in FIGS. 1 and 6. This wedge 188 further supports the cart when it is mounted within the adaptor 180. Again, as with the tongue 186, the wedge 188 may be designed to support different types of carts depending on the specific type and shape of cart to be used and installed in an adaptor.

At the four corners of the adaptor 180 are shock absorbers 195 that are further attached to caster wheels 196. The shock absorbers 195 are attached on one end to the adaptor 180 and on the other end to caster wheels 196. Alternatively, the adaptor 180 may have shock absorbers that do not have wheels and that rest directly on the ground. The shock absorbers 195 are included to help protect the wheels and prevent the adaptor from being damaged in the event of rough handling by a waste truck hauler. In other words, after the adaptor has been lifted and as it is being placed back on the ground, it may be shaken and slammed. Rigid wheels or mounts might be harmed. Also, the adaptor could be bent so that it would not be effective and could not receive a cart.

Finally, there is shown a flap 198 that is merely a flap that is hingedly connected by a bar 199 to the side walls 181. This flap 198 is a mechanism that may be used to lock a waste disposal cart lid in place inside the box or adaptor 181.

As shown in FIGS. 14 and 15, the adaptor 180 is designed to receive two waste carts. Obviously, a single cart may be used with this adaptor. Alternatively, those of skill in the art will understand that an adaptor can be made to receive only one or, even, more than two carts so that they can be lifted by a front-end, dumpster type of lift.

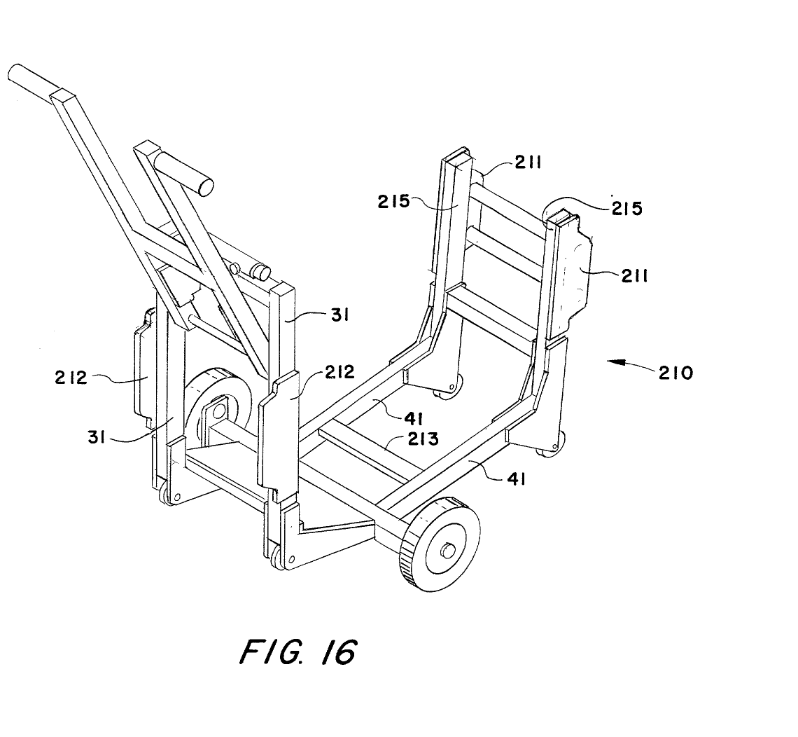

FIG. 16 displays a cart frame 210 that is identical in many respects to the cart frame described in greater detail earlier herein in connection with FIGS. 1 through 6. The differences are important, because they make this particular frame adapted to be received in an adaptor such as shown in FIGS. 14 and 15. First, the frame 210 does not have a front lifter device 14 as shown in FIGS. 1 through 6. The additional features are front engagement plates 211 and rear engagement plates 212. The front plates 211 are fixed to two vertical struts 215. The plates are connected by crossbars 214 to enhance the stability of the front of the frame 210. The rear plates 212 are attached to vertical struts 31 that are similar to the vertical struts 31 described in connection with FIG. 5. Each of the front plates 211 and rear plates 212 include protuberances that stick forwardly (211) and rearwardly (212). The protuberances are used to engage with the structure of the adaptor 180 so that they will be locked into the adaptor 180 when the front gate 183 is closed around a cart. The other difference from the frame disclosed in FIG. 5 is a cross member 213 that is attached at its ends to the bottom 41 of the frame. Aside from these differences noted herein, the frame is similar to that described in FIG. 5 earlier herein. It is intended to carry a container such as container 11. It is designed to be inserted within a waste compactor like the waste compactor described earlier herein.

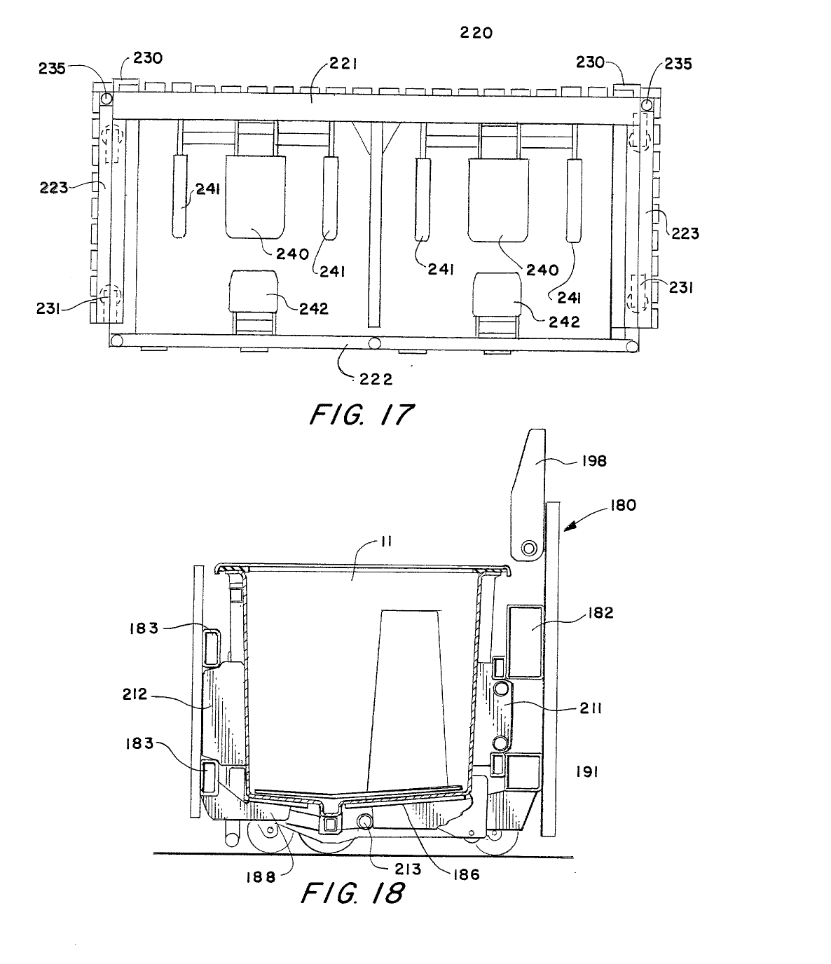

FIG. 17 is a top elevation view of an alternative embodiment of an adaptor 220. The adaptor 220 is very similar to the adaptor 180 shown in FIGS. 14 and 15. The adaptor 220 includes a back wall 221, front gates 222, and side walls 223. There is also shown channels 230 for receiving the prongs for a waste hauling truck. Attached to the back wall 221 is a tongue 240 similar to the tongue 186 described earlier. There are also shown side supports 241 for engaging the bottom of a waste cart. The side supports 241 are included to help balance the cart within the adaptor 220. A rear wedge 242 is attached to the gate 222. It helps carry the weight of the cart along with the tongue 240 and supports 241. The wheel assemblies 231 are shown in dotted lines. The adaptor 220 shown in FIG. 17 also includes pivot stakes 235 in the two rear corners of the adaptor 220. Those stakes 235 will extend from the bottom of the adaptor into the ground. Preferably, a pipe is fixed in the ground and the stakes 235 can be inserted into those pipes. These stakes 235 prevent the adaptor 220 from being moved or rolled about accidentally. Also, if the adaptor is in a difficult place that cannot easily be reached by a truck, one of the stakes 235 may be inserted into the ground and the other removed so that the adaptor 220 may be pivoted or swivelled about so that the channels 230 will be easily accessible to a waste hauling truck. The channels 230 are open at both the front an back sides of the adaptor 220. A waste hauling truck may insert the prongs of the lifter assembly from either side depending on orientation of a cart inside the adaptor. Preferably, the waste hauler will lift the adaptor from the back side. In this way, the gate 220 will be held in place by gravity and will not accidently open during dumping. An additional mechanism may be added to require a waste hauler to lift the adaptor from the preferred back side.

FIG. 18 shows a side, cross-sectional view of the cart having the frame described in FIG. 16. The frame 210 is shown including a container such as container 11 described earlier herein. The frame 210 is mounted within an adaptor such as those shown in FIGS. 14, 15 and 17. The front plate 211 fits in between two parallel members 182 and 191 that make up the back of the adaptor 180. The rear plates 212 are engaged between the horizontal cross members 183 of the front gate of the adaptor 180. Finally, the tongue 186 protrudes between the cross member 213 and the container 11. In this way, when the cart is being emptied and is upside down, the cart cannot fall out even if the front plate 211 and rear plates 212 were to become disengaged with the adaptor, because the tongue 186 would come into contact with the cross member 213 and prevent it from falling out.

While the invention has been described with particular reference to a specific embodiment, in the interest of complete definiteness, it will be understood that it may be embodied in a variety of forms diverse from those specifically shown and described without departing from the spirit and scope of the invention as defined by the appended claims.

What is claimed is:

1. A waste disposal cart comprising:
a container having walls, the container being adapted to receive and hold waste,
wheels attached to the bottom of the cart and adapted to make the cart portable,
a lifter receiving component attached to the cart and comprising a crossbar engagable with a waste cart lifting mechanism, and
wherein the crossbar is positioned above the top of the walls of the container.

2. A waste disposal cart as described in claim 1, wherein the lifter receiving component has upward and downward positions wherein the crossbar is positioned above the top of the walls of the container when in the upward position and below the top of the walls of the container when in the downward position.

3. A waste disposal cart as described in claim 1, wherein the cart is adapted to be removably positioned within a waste compactor apparatus.

4. A waste disposal cart as described in claim 2, wherein the cart is adapted to be removably positioned within a waste compactor apparatus.

5. A waste disposal cart as described in claim 1, further wherein the lifter receiving component further comprises a plurality of vertical hollow tubes, the same number of vertical members slidable up and down within the tubes, and a second crossbar,
wherein the first crossbar is connected to the vertical members and the second crossbar is connected to the vertical hollow tubes.

6. A waste disposal cart comprising:
a container having walls, the container being adapted to receive and hold waste,
wheels attached to the bottom of the cart and adapted to make the cart portable,
lifter receiving means for engaging a waste cart lifting mechanism,
wherein the lifter receiving means is positioned above the top of the walls of the container.

7. A waste disposal cart as described in claim 6, wherein the cart is adapted to be removably positioned within a waste compactor apparatus.
